(19) United States
(12) Patent Application Publication
(10) Pub. No.: US 2020/0098205 A1
(43) Pub. Date: Mar. 26, 2020

(54) SYSTEM AND METHOD FOR DETERMINING DAMAGE

(71) Applicant: Element AI Inc., Montreal (CA)

(72) Inventors: Charles Patrick DUGAS, Montreal (CA); Robert John RIVERSO, Montreal (CA); Carlos BENFEITO, Montreal (CA)

(21) Appl. No.: 16/576,269

(22) Filed: Sep. 19, 2019

Related U.S. Application Data
(60) Provisional application No. 62/734,399, filed on Sep. 21, 2018.

(51) Int. Cl. G07C 5/08; G06N 3/08; G06K 9/00; G06Q 10/00; G07C 5/00

(52) U.S. Cl. CPC G07C 5/0808; G06N 3/08; G06Q 40/08; G06Q 10/20; G07C 5/006; G06K 9/00664

(57) ABSTRACT

Systems and methods relating to vehicle damage detection and assessment. An input dataset of data derived from a vehicle is used to determine if at least one component of a vehicle has been damaged. Suitably trained neural networks are used to determine if a component has been damaged as well as the cost of a repair or replacement of the damaged components. The neural networks may be trained using sensor readings, images of damaged and undamaged vehicles, as well as previous repair or replacement costs.

### RELATED APPLICATIONS

This is a US non provisional patent application which claims the benefit of U.S. provisional patent application No. 62/734,399 filed on Sep. 21, 2018.

### TECHNICAL FIELD

The present invention relates to automated damage detection and assessment. More specifically, the present invention relates to systems and methods for determining if one or more components in a vehicle has been damaged using an input dataset derived from the vehicle.

### BACKGROUND

In automobile insurance, vehicular incidents (also called ‘accidents’, ‘crashes’, or ‘collisions’) represent potential damage to people, vehicles, and other property (including, without limitation, owned objects, owned animals, and land). Thus, each incident represents potential costs to the insurer. Adding to that cost, if an incident has occurred, is the time delay between the incident and an assessment of the damage (if any). Usually, the insurer has to send out one or two agents to assess the damage on a vehicle involved in an incident. As can be imagined, this adds to the cost of the incident as a whole as the agent, his or her time, and the delay all have costs associated with them.

While some attempts have been made to lessen the time between the incident and the damage assessment, none of these attempts, to date, have been sufficient to address the issue. Delays still occur and, the longer the delay, the higher the chance that the parties to the incident may take actions which an insurer may not approve of (e.g., costly rental cars, unverified mechanics, etc.).

Based on the above, there is therefore a need for systems and methods that decreases the delay between an incident and a damage assessment for the vehicle involved in the incident. Preferably, any potential solutions should be robust enough to be applied to other areas of human activity where a timely damage assessment is necessary.

### SUMMARY

The present invention provides systems and methods relating to vehicle damage detection and assessment. An input dataset of data derived from a vehicle is used to determine if at least one component of a vehicle has been damaged. Suitably trained neural networks are used to determine if a component has been damaged as well as the cost of a repair or replacement of the damaged components. The neural networks may be trained using sensor readings, images of damaged and undamaged vehicles, as well as previous repair or replacement costs.

In a first aspect, the present invention provides a method for determining damaged components in a vehicle, the method comprising:
a) receiving, at a data processor, an input dataset, said input dataset comprising data related to a vehicle;
b) determining if said input dataset indicates at least one damaged component in said vehicle;

wherein step b) is accomplished by either:
passing said input dataset through a trained damage detection neural network for determining one or more damaged components in a vehicle; or
comparing said input dataset with a reference dataset to determine if differences between said input dataset and said reference dataset indicate at least one damaged component in said vehicle.

In a second aspect, the present invention provides a system for determining if at least one component in a vehicle has sustained damage in an incident, the system comprising:
an input module for receiving an input dataset, said input dataset comprising data relating to said at least component in said vehicle; and
a damage detection module for determining if said input dataset indicates at least one damaged component in said vehicle, said damage detection module receiving said input dataset from said input module.

### BRIEF DESCRIPTION OF THE DRAWINGS

The present invention will now be described by reference to the following figures, in which identical reference numerals refer to identical elements and in which:

FIG. 1A is a block diagram detailing the components in a system according to one embodiment of the invention;

FIG. 1B is a block diagram of a system according to another embodiment of the invention;

FIG. 2A is a flowchart detailing steps in a method according to another aspect of the invention; and

FIG. 2B is a flowchart detailing the steps in another method according to another aspect of the invention.

### DETAILED DESCRIPTION

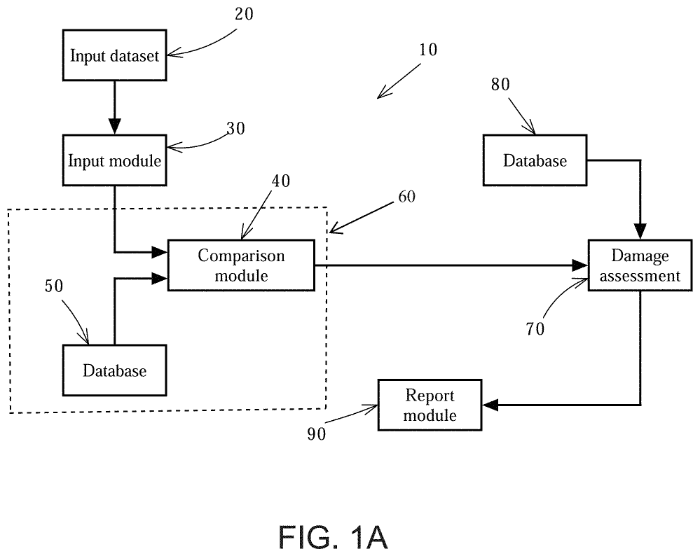

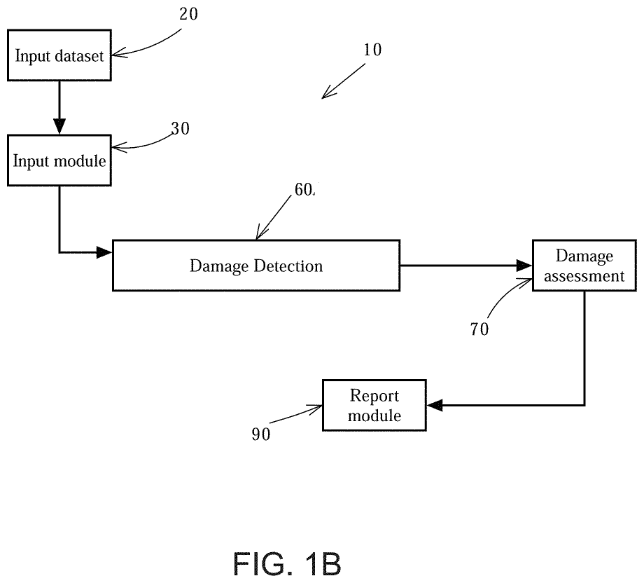

The present invention relates to methods and systems for use in a timely assessment of damage to property due to one or more incidents. Referring to FIG. 1A, a block diagram of a system according to one aspect of the invention is illustrated. As can be seen, the system 10 includes a dataset 20 derived from the potentially damaged vehicle in the incident. This dataset 20 is sent to an input module 30 that adjusts and/or formats the dataset 20 into a suitable form. This formatted dataset 20 is then sent to a comparison module 40 along with a dataset from a database 50. The database 50 contains datasets for undamaged vehicles and provides baseline datasets against which the dataset 20 derived from the vehicle is to be compared.

The comparison module 40, once it receives both datasets, then compares the two datasets to determine if, based on the comparison, the input dataset indicates at least one damaged component in the vehicle. As can be seen, the comparison module and the database are part of a damage detection module 60 that, as a whole, determines if there is damage to the vehicle or to the component/subsystem to which the input dataset relates.

Once it has been concluded that one or more components of the vehicle has sustained damage, this conclusion is then passed to a damage assessment module 70. The damage assessment module 70 then determines if the damaged component or subsystem is suitable for repair or replacement. Regardless of whether repair or replacement is suitable, the cost for such is retrieved from a database 80. The resulting identification of the damaged component/subsystem and the cost of the repair or replacement are then sent to a user by way of a reporting module 90.

It should be clear that the data in dataset 20 derived from the vehicle may take many forms. The dataset 20 may include sensor readings from specific components or sub-systems in the vehicle or it may include one or more digital photographs of parts of the vehicle. The vehicle may have specific sensors for specific subsystems within (e.g. the transmission, the engine, the electrical system, the fuel system, etc., etc.) and each of these specific sensors may produce data that, upon analysis, would indicate whether the subsystem being monitored is operating, operating at some capacity, or is inoperative. As well, the dataset 20 may include sensor readings from sensors that are not directly monitoring specific subsystems but which, upon analysis and comparisons with corresponding datasets from vehicles in operating condition, would indicate that these specific subsystems are not operating properly. As an example, a sensor that monitors oil pressure in the engine could indicate a low reading. This may indicate that an oil pump that feeds oil to a reservoir is either not functioning properly or is not functioning at all. Sensor readings from the various sensors in the vehicle would provide a large amount of data that can form the bulk of the dataset 20.

It should also be clear that the dataset 20 may include specific photographs of the external sections of the vehicle. These photographs may be provided by the vehicle's driver or the insured person. To ensure that a sufficient amount of photographs are provided, the insured person may be directed (e.g. by an insurance related app on a smartphone) to take specific photographs from specific views or poses to ensure sufficient coverage of the vehicle's externals. As an example, the person taking the photographs may be directed to take 3 photos of the left side of the vehicle with one being centered on the left front wheel/tire and being taken from a distance of approximately 5 feet from the vehicle. Another photo would be centered on the gap between the front and back doors and taken from, again, a distance of approximately 5 feet from the vehicle. The third could be centered on the left rear wheel/tire. For a back view, the distance between the camera and the vehicle could be approximately 10 feet and the photo could be centered on the vehicle's license plate. Such views may provide a sufficient view of the left and back portions of the vehicle. These photographs (and photographs of the other sections of the vehicle, including the right and front external sections of the vehicle) can then be compared with suitable photographs or images of sections of undamaged vehicles of a similar make and model.

For external components that are clearly only replaceable (i.e. they cannot be repaired), the person taking the photographs of the vehicle can be provided with a binary checklist to determine whether there is damage to the component. As an example, the front windshield can be dealt with by a yes/no question: IS THE FRONT WINDSHIELD DAMAGED? If the person answers in the affirmative, then the front windshield would need to be replaced and the replacement cost can be factored into the damage assessment report. Similarly, as another example, the driver's side mirror can also be dealt with in the same manner. A binary question for this component could be: IS THE SIDE MIRROR ON THE DRIVER'S SIDE USABLE BY THE DRIVER? If the answer is negative, then this component would need to be replaced and the replacement cost can be factored in.

For internal components (i.e. components inside the cabin of the vehicle), the person using the insurance related app on a suitable computing device (e.g. a smartphone or another portable computing device) can be queried as to whether anything inside the cabin is damaged. If the answer is in the affirmative, then a subsection of questions would query the person as to the status of each component inside the cabin (e.g. the various seats, the steering wheel, the electrical display, the dashboard, the glove compartment, the ceiling light etc., etc.). The components within the cabin may be treated as being exclusively replace only to simplify the process. As such, any damaged component would have its replacement value added to the overall cost of the damage to the vehicle.

It should be clear, however, that whatever means is used to gather data from a user (whether this is an app on a smartphone or an app on a tablet, etc.), there should be a means by which to indicate to the system that the vehicle, as a whole is to be considered a total loss. As an example, a completely crumpled front part of the vehicle or a crushed roof section or a buckled frame would indicate a total loss for the vehicle. To confirm this diagnosis as to the totality of the loss of the vehicle, the system may query the user with a number of specifically broad questions, each of which would be indicative of a total loss of the vehicle. As an example, if the front part of the vehicle is crumpled (indicating a bent frame) or if the side of the vehicle is caved in (again indicating a bent frame), then the vehicle is a total loss. If the user answers questions regarding such damage in the affirmative, then this indicates that the vehicle is a total loss and the dataset 20 would indicate as such. Once such data is flagged by the input module, the system can then bypass the rest of the modules and generate a report indicating the total loss of the vehicle.

For clarity, the dataset 20 may relate to the vehicle as a whole or it may relate to a component or subsystem of the vehicle. When the dataset 20 relates to a component or subsystem of the vehicle, other datasets 20 may be used to determine whether these subsystems or components suffered damage. As an example, a dataset 20 relating to the external left side of the vehicle may be generated by a user. This dataset, once processed, would indicate whether the left side of the vehicle is damaged and what replacement/repair costs are entailed by such damage. Another dataset can then be generated for, as an example, the engine block. This dataset can be generated by the sensors within the engine and, once processed, would indicate which subsystems in the engine (if any) suffered any damage and whether repair or replacement is warranted, along with associated costs. As can be imagined, the system can be used to generate multiple assessments of damage to different vehicle components and/or subsystems. For a complete assessment (for a vehicle that is not a total loss), all the datasets for a vehicle would have to pass through the system to determine the overall cost of whatever damage has been done to the vehicle.

As noted above, the input module 30 may filter and/or format the dataset 20 as necessary. Should the dataset indicate a total loss for the vehicle (as noted above), the system can simply bypass the rest of the components once the input module detects this total loss indication. If the vehicle is not a total loss, then the dataset can be formatted/processed so that it is suitable for processing by the rest of the components. In addition to formatting the dataset or preparing the dataset for processing, the input module can also extract the relevant data from the dataset to determine the year, make, and model of the vehicle. This identification data, along with any identification as to which components or subsystems the dataset relates to, can then be used to retrieve a suitable comparison dataset from the data based 50. As an example, if the dataset 20 indicates that the vehicle in question is a 2010 Honda Accord Coupe and that the dataset (e.g. photographs) relates to a left side of the vehicle, then the system can extract this data and can retrieve photographs or detailed drawings of the left side of an undamaged 2010 Honda Accord Coupe. Similarly, if the dataset relates to sensor readings for engine sensors for a 2016 Tesla Model S 4 door sedan 70D, then the input module would extract this identification from the dataset and would retrieve suitable sensor readings for the same make and model of vehicle from the database 50.

Once the suitable comparison dataset has been retrieved from database 50 and the input dataset 20 has been formatted and processed, these two datasets can then be compared by the comparison module 40. The comparison module 40 can compare sensor reading values and determine whether any differences are within a suitably normal range. If the differences are not within a suitable range, then this difference is noted when determining if damage has been sustained. However, if the differences are within the normal operating range, then this is noted again when deciding whether damage has been sustained.

It should be clear that the comparison module 40 is capable of comparing images or photographs as well. To compare two images, images or photographs or drawings from either the reference dataset (from the database 50) or the input dataset 20 can be manipulated, rotated, magnified or otherwise adjusted to that the images being compared are as similar as possible with respect to vantage point. Then, once the images are suitably similar and can be compared, image subtraction or image overlaying or any other method may be used to determine what differences, if any, exist between the images. Again, the differences may be digitized or reduced to numerical values to provide a numerical indication as to differences between the images. The comparison module can then indicate whether these differences are within suitable tolerance limits (i.e. acceptable) or not. If these differences are not within suitable tolerance limits, then an indication as to how different the compared images can be sent to the next module.

In addition to determining the differences between the two datasets, the comparison module also decides whether, based on the differences, the input dataset indicates a damaged component or subsystem. In one implementation, a rules-based deterministic submodule may be used such that if the differences between the input dataset and the reference dataset exceed a specific threshold, then the conclusion is that damage has occurred. In another implementation, a machine learning submodule may be used (e.g. one that incorporates a neural network). Such an implementation that uses a comparison neural network may be trained with one or more suitable training sets that include sensor readings for damaged and undamaged subsystems, images for damaged and undamaged parts/components of vehicles, and user entries indicating damaged and undamaged parts/components of vehicles. A suitably trained neural network can then provide probabilities that damage has occurred or that damage has not occurred. In addition, depending on the training sets used, the neural network may also provide indications as to a percentage of damage. This indication whether damage has occurred and, if damage has occurred, the percentage of damage may then be used by the next module in the system.

As an alternative to the above, instead of determining the differences between the two datasets and then passing the differences to the comparison neural network to determine if damage has occurred, the two datasets may be directly passed through a trained comparison neural network. This trained comparison neural network, preferably trained on a training set that includes datasets (e.g. sensor readings and/or images) from both damaged and undamaged vehicles, can then determine whether the two datasets, taken together, indicate at least one damaged component in the vehicle.

Once a conclusion that there is damage has been reached, this conclusion, along with a potential percentage of damage, may then be sent to a damage assessment module 70. The damage assessment module 70, depending on the implementation, may provide an indication as to whether a damaged component or subsystem is suitable for repair or replacement. This indication may be based on the percentage of damage data received from the decision module 60. The indication of whether a repair or a replacement would be necessary may be component/subsystem dependent as well as damage dependent. Some components/subsystems may, by their very nature, be non-repairable and, as such, any damage would indicate that a replacement is necessary. As an example, if a front driver side door on a car is damaged, that door would need to be replaced. Similarly, a broken or damaged front grille would also need to be replaced as opposed to being repaired. However, a malfunctioning transmission may, depending on the amount of damage sustained, may be a candidate for a repair. As well, a scratched cylinder inside the engine block may be re-bored to repair the damage as opposed to replacing the whole engine.

In addition to the indication as to whether a repair or a replacement is indicated by the damage, the damage assessment module 70 cooperates with a database 80 to provide costs for the indicated repair or replacement. Once a repair or replacement is noted as being necessary for a damaged component or subsystem, the module 70 then retrieves data from database 80 as to the cost for that repair or replacement. Since the make, model, and year of the vehicle is known (from the input dataset 20), and since, in this implementation, database 80 contains prices for parts and an estimate of labor costs, then the module 70 can determine how much the replacement parts will cost or how much repair costs will be. These data points can be retrieved and then passed on to the next module in the system.

After the costs for either replacement or repair of the damaged components have been determined, the system can then send these costs to the report module 90. A suitable report for the specific component/subsystem being monitored by the input dataset 20 can then be created. Preferably, the report includes details such as the make, model, and year of the vehicle, the component and/or subsystem being assessed, the percentage of damage (if determined), and the cost of repair or replacement of the component/subsystem.

As noted above, the input dataset may be gathered directly from the vehicle by way of sensors installed on the vehicle. Such sensors may be coupled to a server by way of wireless communications link between the vehicle and the server. Alternatively, the sensors and their readings may be accessed by a communications link between the vehicle and a suitably configured and programmed computing device (e.g. a computer, smartphone, or tablet). Accordingly, depending on the implementation, the sensor readings may be transmitted from the vehicle to the server in real-time or near real-time.

It should be clear that, as noted above, input dataset data may be gathered from a user who operates computing device that executes a program or an app on the computing device. The user may be directed to operate or at least turn on the vehicle's engine and other systems so that the computing device can receive sensor readings from suitable sensors in the vehicle. As well, the user may be directed to turn on the engine and be directed to answer specific questions regarding the operation of the vehicle. Of course, if the user is unable to operate the vehicle or even turn on the engine (e.g. the engine is inoperative or the vehicle is too damaged to operate), the user will have the option to indicate as such to the computing device's program. Such an input will be detected by the input module and may cause the system to declare the vehicle to be a complete loss.

Referring to FIG. 1B, another implementation of a system according to the present invention is illustrated. As can be seen, the system 10 in FIG. 1B is very similar to the system in FIG. 1A. The main difference between the systems in FIGS. 1A and 1B is the lack of databases in FIG. 1B. In addition, the implementation in FIG. 1B simply has a damage detection module 60 and does not use a comparison module. For this implementation, the damage detection module 60 uses a suitably trained damage detection neural network. The damage detection neural network would directly receive the formatted/processed input dataset from the input module and, based on this dataset, would determine if at least one component in the vehicle has been damaged. Once the damage detection module has determined that damage has been sustained, the system then passes data to the damage assessment module 70. Based on the identification of the damaged component/subsystem (and perhaps an indication of the damage), the damage assessment module determines the cost of the repair or replacement warranted by the damage. Once the cost has been determined, the report module 90 produces a suitable report as explained above.

It should be clear that the damage detection neural network can be trained using suitable training datasets that include datasets for both damaged and undamaged vehicles. As well, the output of the damage detection neural network (a decision as to whether there has been damage or not) can be sent to a user in parallel to being sent to the damage assessment module. The user can then validate the decision and the input dataset and the decision can be used in future training sets for the damage detection neural network. This can be easily implemented should the input dataset include images as a user can simply view the image to determine if damage has been sustained or not. For erroneous decisions, this validation feedback loop can be quite useful as the erroneous decisions and the input datasets that generated them, when used in a training set for the damage detection neural network, can operate to correct such behaviour from the neural network. It should be noted that this validation feedback loop is not illustrated in FIG. 1A but can be easily implemented if desired.

Similar to the damage detection module 60, the damage assessment module 70 can use a suitably trained damage assessment neural network. Instead of using a database to look up the costs for repairs or replacements, the damage assessment neural network can, on its own, estimate the costs for damaged components. The damage assessment neural network can be trained using data from previous repairs and replacement of damaged components. A database of repairs or replacements, along with an identification of the component being replaced or repaired can be used to train the damage assessment neural network. Once trained, the damage assessment neural network should be able to estimate the cost of a repair or replacement based on the identification of the damaged component and perhaps based on the extent of the damage. Once the suitable repair or replacement of the component has been accomplished, the real world cost can then be used as a data point in a training set for the damage assessment neural network. Thus, as more estimates are generated, more data for a suitable dataset can be gathered to thereby improve the accuracy of subsequent cost estimates.

Note must be made that the system detailed above and its variants may also be used to detail any damage to other insurable property such as real property or other types of property. For implementations that may not be suitable for sensors to be installed on the property or for implementations that do not readily lend themselves to similar sensors, detailed and directed questionnaires may be used. These questionnaires may be implemented by way of apps or applications on portable computing devices to gather data for a suitable input dataset that can be used with a similar system to determine any damage to such property.

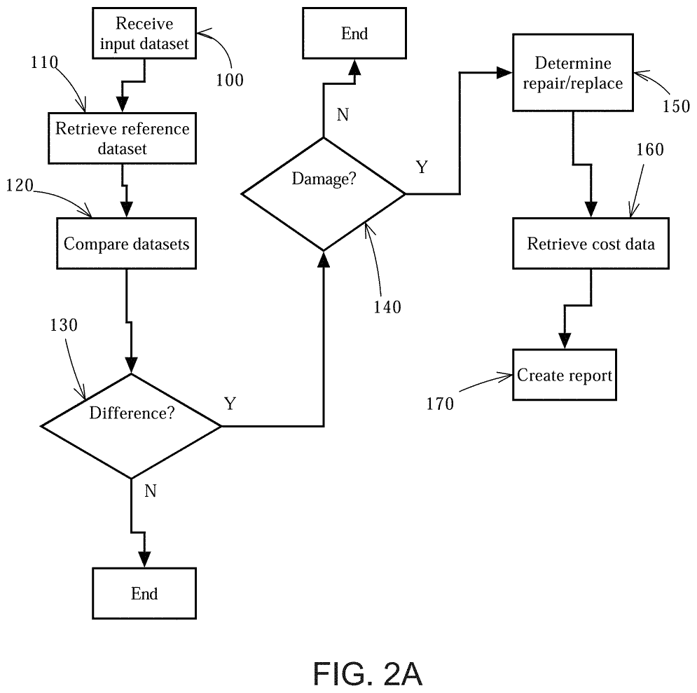

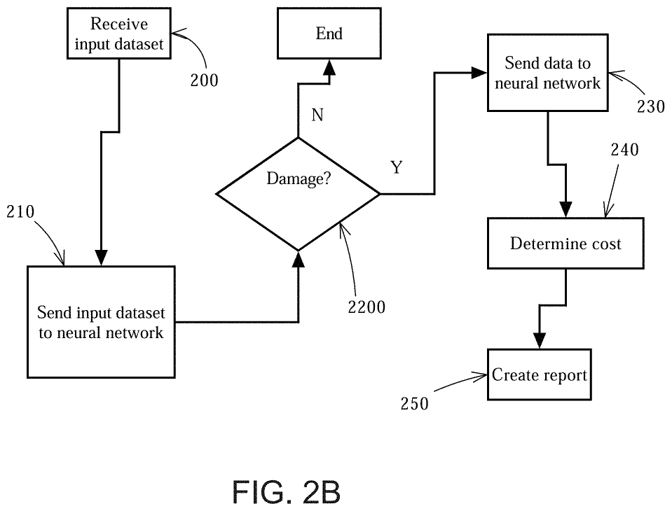

Referring to FIG. 2A, a flowchart detailing the steps in a method according to another aspect of the present invention is illustrated. The method begins at step 100, that of receiving an input dataset from a computing device with the input dataset relating to one or more components or subsystems of a vehicle. Step 110 is that of retrieving a corresponding reference dataset for the components or subsystems to which the input dataset relates to. As noted above, the input dataset would include identification data for the vehicle as well as for the component/subsystem to which the dataset relates to. This enables the retrieval of a reference dataset to which the input dataset is to be compared with.

After both the input dataset and the reference dataset are available, they are compared to each other (step 120). A decision 130 then determines if there is a difference between the two datasets. Of course, if the difference is within acceptable limits or within an expected range, then decision 130 is answered in the negative. Once this occurs, the method ends and a conclusion is reached that no damage is indicated by the input dataset. However, if the difference is outside the expected range or outside acceptable limits, then decision 130 is answered in the affirmative. A second decision 140 is then determined if decision 130 is answered in the affirmative. Decision 140 determines if the difference between the input and reference datasets indicates damage to the component/subsystem being assessed. As noted above, the determination as to whether damage has been incurred may be rules based or it may be determined using machine learning. If decision 140 indicates that no damage has occurred, then the method ends.

In the event decision 140 indicates that damage has been incurred, then step 150 determines if the damaged component/subsystem is to be repaired or replaced. After this determination is performed, then the cost of the determined action (repair or replace) is then retrieved. As noted above, these costs can be determined from a suitable database, especially as the make, model, and year of the vehicle is known along with the identity of the component. After the costs have been retrieved, a suitable report is then created (step 170). As should be clear, the method detailed in FIG. 2 can be executed by the system illustrated in FIG. 1.

Referring to FIG. 2B, another method according to another aspect of the present invention is illustrated. This method begins at step 200, that of receiving an input dataset. The input dataset is then sent to a damage detection neural network (step 210). The neural network then determines the result of decision 220, that of whether damage has occurred. If no damage has occurred, then the method ends. Alternatively, if damage has been determined to have occurred, then data is sent to a damage assessment neural network (step 230). In step 240, the cost for the repair or replacement of the damaged component is then estimated using the damage assessment neural network. A report is then generated in step 250. As should be clear, the method in FIG. 2B can be executed by the system in FIG. 1B.

It should be clear that the various aspects of the present invention may be implemented as software modules in an overall software system. As such, the present invention may thus take the form of computer executable instructions that, when executed, implements various software modules with predefined functions.

Additionally, it should be clear that, unless otherwise specified, any references herein to ‘image’ or to ‘images’ refers to a digital image or to digital images, comprising pixels or picture cells. Likewise, any references to an ‘audio file’ or to ‘audio files’ refer to digital audio files, unless otherwise specified. ‘Video’, ‘video files’, ‘data objects’, ‘data files’ and all other such terms should be taken to mean digital files and/or data objects, unless otherwise specified.

The embodiments of the invention may be executed by a computer processor or similar device programmed in the manner of method steps, or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g., “C” or “Go”) or an object-oriented language (e.g., “C++”, “java”, “PHP”, “PYTHON” or “C #”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems.

Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

What is claimed is:

1. A method for determining damaged components in a vehicle, the method comprising:
a) receiving, at a data processor, an input dataset, said input dataset comprising data related to a vehicle;
b) determining if said input dataset indicates at least one damaged component in said vehicle;
wherein step b) is accomplished by either:
passing said input dataset through a trained damage detection neural network for determining one or more damaged components in a vehicle; or
comparing said input dataset with a reference dataset to determine if differences between said input dataset and said reference dataset indicate at least one damaged component in said vehicle.

2. The method according to claim 1, wherein said method further comprises a step of:
c) in the event step b) indicates at least one damaged component, determining a cost of replacement or repair of said at least one damaged component.

3. The method according to claim 2, wherein said method comprises a step of determining if said input dataset indicate that said vehicle is a total loss.

4. The method according to claim 1, wherein said input dataset comprises at least one of:
sensor data from at least one sensor attached to at least one component of said vehicle; and
digital images of sections of said vehicle.

5. The method according to claim 1, wherein said differences indicate at least one damaged component in said vehicle if said differences exceed a predetermined threshold.

6. The method according to claim 1, wherein comparing said input dataset with said reference dataset comprises passing said differences through a trained comparison neural network to determine if said differences indicate at least one damaged component in said vehicle.

7. The method according to claim 2, wherein said cost of replacement or repair is retrieved from a database.

8. The method according to claim 2, wherein said cost of replacement or repair is determined by passing said input data through a trained assessment neural network.

9. The method according to claim 1, wherein said reference dataset comprises at least one of:
sensor data from at least one sensor attached to at least one component of an undamaged vehicle; and
digital images of sections of said undamaged vehicle;
wherein said vehicle and said undamaged vehicle are of a same make, model, and year.

10. The method according to claim 1, wherein said damage detection neural network is trained using at least one training dataset comprising at least one of:
sensor data from at least one sensor attached to at least one component of a damaged vehicle; and
digital images of sections of a damaged vehicle.

11. The method according to claim 1, wherein said damage detection neural network is trained using at least one training dataset comprising at least one of:
sensor data from at least one sensor attached to at least one component of an undamaged vehicle; and
digital images of sections of an undamaged vehicle.

12. The method according to claim 8, wherein said trained assessment neural network is trained using a training dataset comprising costs for repairing or replacing damaged components for various makes, models, and kinds of multiple vehicles.

13. A system for determining if at least one component in a vehicle has sustained damage in an incident, the system comprising:
an input module for receiving an input dataset, said input dataset comprising data relating to said at least component in said vehicle; and
a damage detection module for determining if said input dataset indicates at least one damaged component in said vehicle, said damage detection module receiving said input dataset from said input module.

14. The system according to claim 13, wherein said damage detection module comprises
a comparison module for comparing said input dataset and a reference dataset to determine differences between said input dataset and said reference dataset, said comparison module receiving said input dataset from said input module;
wherein
said comparison module also determines if said differences between said input dataset and said reference dataset indicate that said at least one component has sustained damage.

15. The system according to claim 13, wherein said system further comprises a damage assessment module for determining if said at least one component that has sustained damage is suitable for repair or replacement.

16. The system according to claim 15, wherein said damage assessment module is further for determining a cost of said repair or replacement.

17. The system according to claim 14, further comprising at least one database, said at least one database being for storing data for use in said reference dataset.

18. The system according to claim 14, wherein said comparison module comprises at least one trained comparison neural network for determining if said differences indicate that said at least one component has sustained damage.

19. The system according to claim 15, further comprising a report module for generating a report regarding whether said at least one component has sustained damage, said report module receiving data from said damage assessment module.

20. The system according to claim 15, wherein said damage assessment module comprises a trained assessment neural network that is trained using at least one training dataset comprising costs for repairing or replacing damaged components for various makes, models, and kinds of multiple vehicles.
